(19) United States
(12) Patent Application Publication
(10) Pub. No.: US 2010/0221694 A1
(43) Pub. Date: Sep. 2, 2010

(54) ADAPTIVE ELECTRONIC LEARNING SYSTEM AND METHOD

(75) Inventor: Kalia MOSHENBERG, Haifa (IL)

Correspondence Address: Fleit Gibbons Gutman Bongini & Bianco PL, 21355 EAST DIXIE HIGHWAY, SUITE 115, MIAMI, FL, 33180, US

(73) Assignee: BLOSSOM E-LEARNING LTD., Shoham (IL)

(21) Appl. No.: 12/779,330

(22) Filed: May 13, 2010

Related U.S. Application Data
(63) Continuation-in-part of application No. PCT/IL2008/001501, filed on Nov. 13, 2008.
(60) Provisional application No. 60/987,579, filed on Nov. 13, 2007.

(51) Int. Cl. G09B 7/00

(52) U.S. Cl. 434/362

(57) ABSTRACT

A method of challenging a student may comprise obtaining an initial performance-level-value which may be a specific performance level value respective of, e.g., a specific student; obtaining an initial set of computerized tasks, each task in the initial set has a respective challenge-level-value correlated with the initial performance-level-value; challenging the student with one or more of the computerized tasks being members in the initial set and collecting performance information respective of performance of the student; comparing the performance information with success-threshold-information to yield comparison results; determining an adapted performance-level-value respective of the student in accordance with the initial performance-level-value and the comparison results; obtaining an adapted set of computerized tasks, each task in the adapted set has a respective challenge-level-value corresponding with the adapted performance-level-value; and challenging the student with one or more of the computerized tasks being members in the adapted set.

### CROSS-REFERENCE TO RELATED APPLICATIONS

This patent application claims priority from U.S. Provisional Application 60/987,579 filed on Nov. 13, 2007, the disclosure of which is incorporated herein by reference in its entirety.

### FIELD OF THE INVENTION

The present invention concerns the field of electronic learning in general, and methods for adaptive electronic learning in particular.

### BRIEF DESCRIPTION OF THE DRAWINGS

In order to understand the invention and to see how it may be carried out in practice, embodiments will now be described, by way of non-limiting examples only, with reference to the accompanying figures, in which:

FIG. 1 is a schematic block diagram illustration of an adaptive e-learning system, according to some embodiments of the invention;

FIG. 2 is a schematic block diagram illustration of a storage unit of the adaptive e-learning system, according to some embodiments of the invention;

FIG. 3 is a schematic flow-chart illustration of a method for challenging a student using the automatically adapted performance-level-values respective of the student, according to some embodiments of the invention; and

FIG. 4 is a schematic flow-chart illustration of a method for challenging a student using automatically adapted challenge-level-values respective of a computerized task, according to some embodiments of the invention;

FIG. 5 is a schematic flow chart illustration of a method for allowing navigation between screenshots of a computerized application, according to some embodiments of the invention; and

FIG. 6A is a schematic block diagram illustration of an appearance of a first screen of the computerized application, according to some embodiments of the invention;

FIG. 6B is a schematic block diagram illustration of a first screenshot of the first screen, according to some embodiments of the invention;

FIG. 7A is a schematic block diagram illustration of an appearance of a subsequent screen of the computerized application, according to some embodiments of the invention; and

FIG. 7B is a schematic block diagram illustration of a subsequent screenshot of the subsequent screen of the computerized application, according to some embodiments of the invention

The drawings taken with the description thereof make apparent to those skilled in the art, how the invention may be embodied in practice. Where considered appropriate, reference numerals may be repeated among the figures to indicate identical elements.

### DESCRIPTION OF THE INVENTION

### Summary of the Embodiments Invention

The present invention discloses a method of challenging a student may comprise obtaining an initial performance-level-value which may be a specific performance level value respective of, e.g., a specific student; obtaining an initial set of computerized tasks, each task in the initial set has a respective challenge-level-value correlated with the initial performance-level-value; challenging the student with one or more of the computerized tasks being members in the initial set and collecting performance information respective of performance of the student; comparing the performance information with success-threshold-information to yield comparison results; determining an adapted performance-level-value respective of the student in accordance with the initial performance-level-value and the comparison results; obtaining an adapted set of computerized tasks, each task in the adapted set has a respective challenge-level-value corresponding with the adapted performance-level-value; and challenging the student with one or more of the computerized tasks being members in the adapted set.

The present invention further discloses a method for allowing navigation between screenshots of a computerized application. In embodiments of the invention, the method comprises the following acts: obtaining an appearance of a first screen and an appearance of a subsequent screen of a computerized application, wherein the subsequent screen is obtainable further to receiving a corresponding application-related input; obtaining a first screenshot of the appearance of the first screen and a subsequent screenshot of the appearance of the subsequent screen; automatically linking a navigation interface to the first screenshot of the first screen, for allowing navigation to the subsequent screenshot by obtaining input similar to the application-related input.

### Detailed Description of the Embodiments of the Invention

The field of electronic learning, which is known as “eLearning”, “e-learning” or “elearning”, is concerned with challenging students with computerized tasks. The term “student” as used herein refers to an entity challenged with one or more computerized tasks. Such an entity may be interchangeably embodied by a person and a computerized module using the computerized system for learning, for example, the usage or operation of an electronic device and/or of a software application. Such an electronic device may be embodied, for example, by a personal computer, a desktop computer, a cellular mobile device, a laptop computer, a handheld electronic device, a handheld personal digital assistant, a notebook computer, a mobile or portable computer, an e-reading device, a tablet computer and a simulator (e.g., a flight simulator, a weapons simulator). The software application may be embodied, for example, by a word processing application, a spreadsheet application, a software development application, a gaming application, an enterprise resource planning (ERP) application, a database application, an electronic mail application, a webmail application, a statistical analysis application, an internet-based application, a mental training application, an operating system, a personal computer application, a mobile device application, a server application, an application for recording and/or arranging and/or editing of audio and/or video files, a simulator application, an automation application, an emulator application, and a household appliance application. It is noted that learning is not limited to a specific field in the art.

The term “computerized task” as used herein refers to any task that is accomplishable within the framework of the electronic device and/or software application and for which at least one predefined step is required to be undertaken by a user of the electronic device and/or software application such to accomplish at least one of any of an application-specific tasks for which the software application and/or the electronic device was devised. Such an application-specific task may refer, inter alia, to any executable function integral of the electronic device and/or software application such as, for example, the opening of a file, the editing of a file, the closing of a file, the importing of file, the exporting of a file, the merging of at least two files, the splitting of at least two files, the recording of macro functions, the analysis of a file (e.g., statistical analysis, word counting) and the like. Clearly, the above-listed executable functions are by way of example only and should by no means to be construed as limiting.

The present invention discloses, inter alia, an e-learning content creator (hereinafter “content creator”) that is operatively associatable and with an existing software application and/or electronic device. The existing software application and/or electronic device is herein referred to as “host application”. Moreoever, the content creator is customizable by a user according to the specific host application. Considering for example, the Microsoft WORD application, the content creator enables the user of the Microsoft WORD application to record the steps required for performing a specific task. Considering a first task such as, for example, the printing of a WORD document, the steps required for performing said first task can be recorded by the content creator. In addition, a challenge-level-value is associatable with each of the said steps by said content creator. Considering a second, more complex task, such as, for example, generating different headers in the document, the content creator enables the association of the steps required for accomplishing the second task with a second, higher challenge-level-value. It should be noted that in some embodiments, the content creator also enables the association of at plurality of challenge-level-values respective of the steps required for accomplishing a given task. In any event, the recording of the steps by the content provider includes at least the procedure of storing at least one input information such as for example, keyboard input and/or pointing device input and/or voice command input as provided by the user during the performance of a task, whereby the input information contains position information (e.g., position of a mouse cursor during input), sequence information (i.e., information about previous inputs), and optionally timing information (e.g., the timing between two different inputs).

In accordance with certain embodiments of the invention, a method of challenging a student using automatically adapted performance-level-values respective of the student, comprises, obtaining an initial performance-level-value, obtaining an initial set of computerized tasks, wherein each task in the initial set has a respective challenge-level-value that corresponds with the initial performance-level-value; challenging the student with one or more of the computerized tasks being members in the initial set and collecting performance-information respective of execution of the initial set of tasks by the student; comparing the collected performance-information respective of the execution of the initial set of tasks by the student with a success-threshold-information to yield comparison results; determining an adapted performance-level-value respective of the student in accordance with the initial performance-level-value and the comparison results; obtaining an adapted set of computerized tasks, each task in the adapted set has a respective challenge-level-value correspondent with the adapted performance-level-value; and challenging the student with one or more of the computerized tasks being members in the adapted set of computerized tasks.

The performance level value may be respective of at least one of the following: a specific student; a general performance level value respective of a group of students; a general performance level value respective of all students; and a predefined default value.

Further in some other embodiments of the invention, a method of determining an adapted challenge-level-value respective of one or more computerized tasks, may comprise: obtaining an initial challenge-level-value for the computerized task(s); confronting one or more students with the computerized task(s) and collecting collected performance information respective to the execution of the computerized task(s) by one or more of the students; determining a success level respective of the computerized task in accordance with said collected performance information; and updating the challenge-level-value in accordance with the success level.

According to certain embodiments of the present invention presented below, adaptive e-learning methods and systems are disclosed, that enable challenging of a student, with a plurality of sets of one or more computerized tasks. Each computerized task has associated therewith a challenge-level-value respective to each set, whereby the challenge-level-value may correspond to the degree of difficulty of the computerized task.

It should be noted the term “degree of difficulty” as specified herein may be derived experimentally using, for example, statistical methods, as known to those versed in the art. For example, one or more students may be challenged with a plurality of computerized tasks, wherein each student is asked to grade the difficulty of each of the computerized tasks, whereupon the grades respective to each task may be averaged. The obtained average grade respective to each task may correspond to a respective challenge-level-value.

According to one embodiment of the invention, the student is challenged with at least one computerized task of an initial set, whereby an initial performance-level-value may be associated with the student. It is noted that it is not obligatory, according to the embodiment, to challenge the student with all the tasks being members of the set. Hence, it is possible to challenge the student with one or more of the computerized tasks being members in the initial set. For example, it is possible that the initial set includes to several tasks having different challenge level-values, while it is allowed to challenge the student only with those tasks whose challenge-level-values is in a certain predetermined range, while not challenging him/her, at this stage, with the other tasks that are not within the said predetermined range of challenge-level-values.

The information respective of the accomplished performance of the student, who is challenged with one or more of the computerized tasks, at one or more opportunities, is collected by the adaptive e-learning system to constitute “performance information”.

According to certain embodiments, the performance information can include a set of numbers grading the student's execution of one or more computerized tasks. The performance information is then compared with success-threshold-information to yield comparison results. Such success-threshold-information may represent for example a predefined threshold value representing a requirement pertaining to the successful execution of the one or more computerized task by the student, whereby meeting and/or exceeding the predefined requirement results in determining an adapted-performance-level-value respective to the same student. The success-threshold-information may, e.g., depend on one or more parameters such as, for example, the minimum number of tasks that have to be executed correctly, or the minimum number of tasks that have to be executed correctly within a predetermined time span. For example, a user of an adaptive e-learning system operating in accordance with embodiments of the invention may define that 4 tasks being members of the same set of tasks that have to be executed correctly by the student within, e.g., 30 seconds, in order to determine an adapted initial performance-level-value respective to the student in accordance with the initial performance-level-value and the comparison result(s). Therefore, if the comparison between the performance information and the success-threshold-information yields that the execution of the tasks by the student meets the requirements as defined by the said success-threshold-information, an adapted performance-level-value respective of the student may be determined. Further, the student is challenged with another set of at least one computerized task associated to one or more given challenge-level-values that correlate with the adapted performance-level-value. For example, if the execution of the tasks meets the requirements as represented by means of the success-level-information, then the one or more adapted challenge-level-values are on the average higher than, e.g., the average or median value of the initial challenge-level-values. Conversely, if the execution of the tasks does not meet the requirements as represented by means of the success-level-information, then the one or more adapted challenge-level-values may be lower than, e.g., the average or median value, of the initial challenge-level-values or the initial challenge level value may remain with no change.

An example of how to perform a comparison between performance information and the success-threshold-information is provided herein: A student may be defined as having an initial performance-level-value of 60 and may be challenged with a set of 10 computerized tasks having related therewith a success-threshold-information predefined as 1. In the example the student successfully performed 8 computerized tasks, while other students on the average successfully perform only 6 out of the 10 tasks. Thus, the comparison of the said results yields a comparison result of 8/6=1.33. Subsequently an adapted performance-level-value of 60*1.33=80 may be determined for the said student. Correspondingly, an adapted challenge-level-value may be determined. It should be noted that the comparison between the performance information and the success-threshold-information may be performed in many other ways. For example, the average number of successfully computerized tasks (e.g., 6) may be subtracted from the number successfully executed tasks (e.g., 8) by the student. The comparison may thusly yield a result of 8−6=2, which may then be multiplied with the initial performance-level-value.

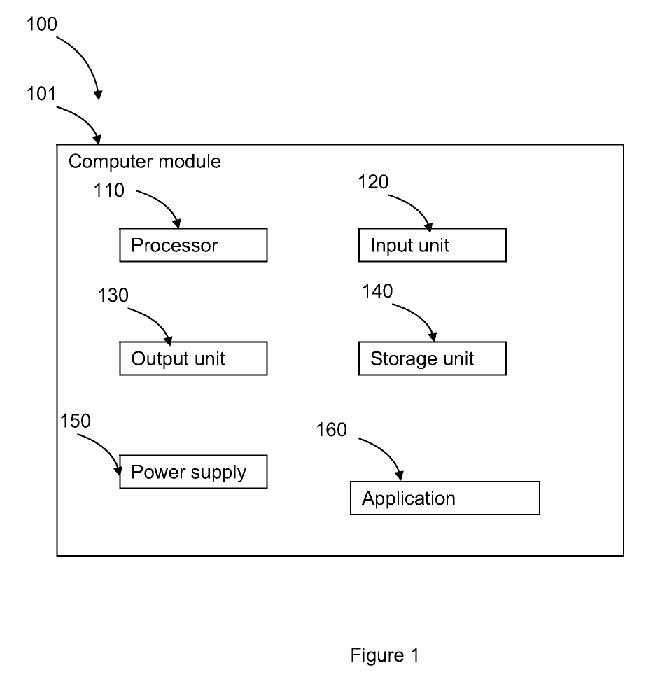

Reference is now made to FIG. 1, which is a schematic block diagram illustration of an adaptive e-learning system, according to some embodiments of the invention. According to some embodiments of the invention, an adaptive learning system 100 may include a computer module 101, which may include a processor 110, an input unit 120, an output unit 130 and a storage unit 140, all of which may be operatively linked to a power supply 150.

According to some embodiments of the invention, storage unit 140 may store therein data representing a plurality of sets of computerized tasks, whereby each computerized task may have corresponding therewith a challenge-level-value.

More specifically, the computerized tasks may be stored in sets embodying one or more computerized tasks with similar challenge-level-values, determining together the challenge-level-value of the said set. Each such set may relate to a predefined performance-level-value (not shown). Other sets can be formed using a different method of associating, such as subject, type of task etc.

It should be noted that in some embodiments of the invention, the performance-level-value is embodied by the challenge-level-value, i.e., it is possible that the performance-level-value and the challenge-level-value are the same data-entity.

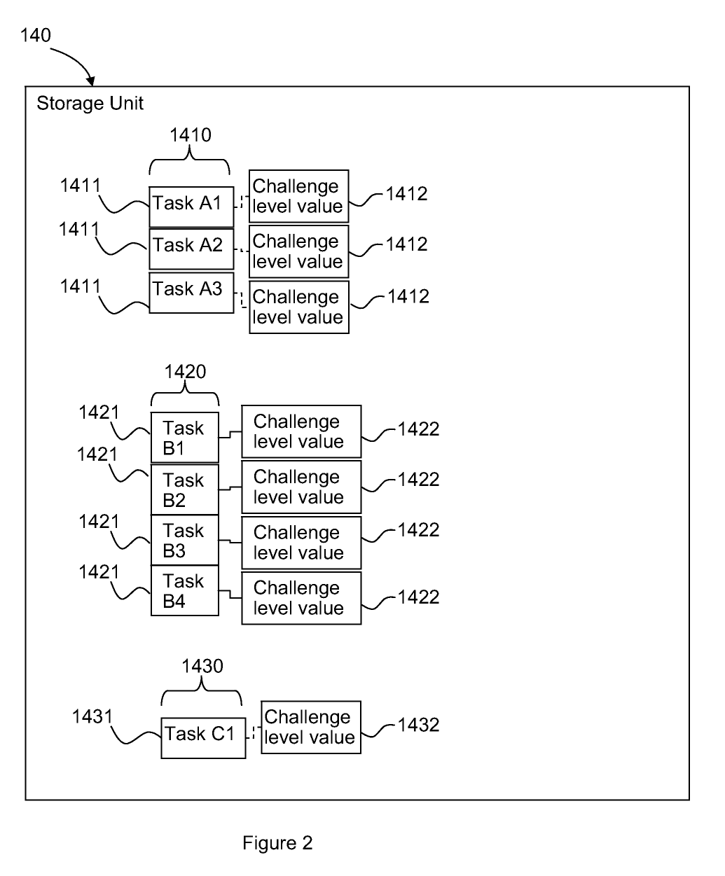

FIG. 2 is a schematic block diagram illustration of a storage unit of the adaptive e-learning system, according to some embodiments of the invention. For exemplary purposes only, the plurality of sets of computerized tasks is hereinafter referred to as “set 1410”, “set 1420” and “ set 1430”, whereby computerized tasks A1, A2 and A3 may constitute set, 1410; computerized task B1, B2, B3 and B4 may constitute set 1420; and computerized task C1 may constitute set 1430. The computerized tasks constituting sets 1410, 1420 and 1430 may correspond with challenge-level-values 1412, 1422 and 1432, respectively. In storage unit 140 the challenge-level-values may correspond to determined performance-level-values. For example, performance-level-values ranging from, e.g., 1 to 33, may correspond with challenge-level-value 1412, performance-level-values ranging from, e.g., 34 to 66 may correspond with challenge-level-value 1422, and performance-level-values ranging from 67 to 100 may correspond with challenge-level-value 1432, whereby challenge-level-values 1412, 1422 and 1432 may hold the values 1, 2 and 3, respectively.

Yet, this is non-limiting as in other embodiments of the invention, the same performance-level-value may relate to different sets of computerized tasks and therefore to different challenge-level-values. For example, a performance-level-value representing the value 50 may relate to both sets 1410 and 1420.

It is noted that the challenge-level-values and the performance-level-values brought in the current example are brought by way of example only. Accordingly, additional or alternative levels and/or scales are allowed as well.

It should be noted that one or more computerized tasks being members in the initial set may be similar to one or more of the computerized tasks being members in the adapted set.

For example computerized tasks A1, A2 and A3 may constitute the initial set while computerized tasks B1 and A1 may constitute the adapted set.

Storage unit 140 may further include instructions, which, when executed by processor 110 result in an application 160 that, inter alia, initially challenges a student via output unit 120 with a one or more tasks of the same set e.g., set 1410, having related therewith an initial performance-level-value of, e.g., 2.

It should be noted that in some embodiments of the invention, the student may be challenged by default with a specific computerized task being a member of the corresponding set. However, in some other embodiments of the invention, a user of adaptive learning system 100 may determine which should be the initial set of computerized tasks. Yet alternatively a computerized task may automatically determine the initial set of computerized tasks, e.g., by using random or semi-random selection, or in accordance with any relevant criteria or criterion.

In some embodiments of the invention, adaptive learning system 100 is additionally adapted to receive or collect from the student via input unit 120 performance information by means of input data representing the execution of the at least one task. Performance information may comprise, for example, the number of computerized tasks correctly executed by the student, the time required by the student to execute the tasks, and the like.

According to certain embodiments, application 160 then compares the performance information with the success-threshold-information yielding a comparison result. Depending on the comparison result, application 160 may retain the initial performance-level-value or determine an adapted performance-level-value and challenge the student with an adapted set of computerized tasks corresponding with the challenge-level-value that corresponds with the adapted performance-level-value. If for example, the comparison result is, e.g., above a predetermined threshold value, then application 160 may determine a higher performance-level-value to the said student and subsequently challenge the student with an adapted set of computerized tasks. However, in the event that the comparison result is, for example, equal or below the predetermined threshold value, application 160 may retain the initial performance-level-value or alternatively, determine that the student has a performance-level-value which is lower than the initial performance-level-value.

It should be noted that as already indicated hereinabove the initial set of computerized tasks with which the student is challenged, may be determined in accordance with an initial performance-level-value, which was obtained prior to having determined the current performance-level-value in response to the at least one computerized task of the initial set.

The initial performance-level-value may be predetermined, or may be obtained in response to one or more preceding computerized tasks.

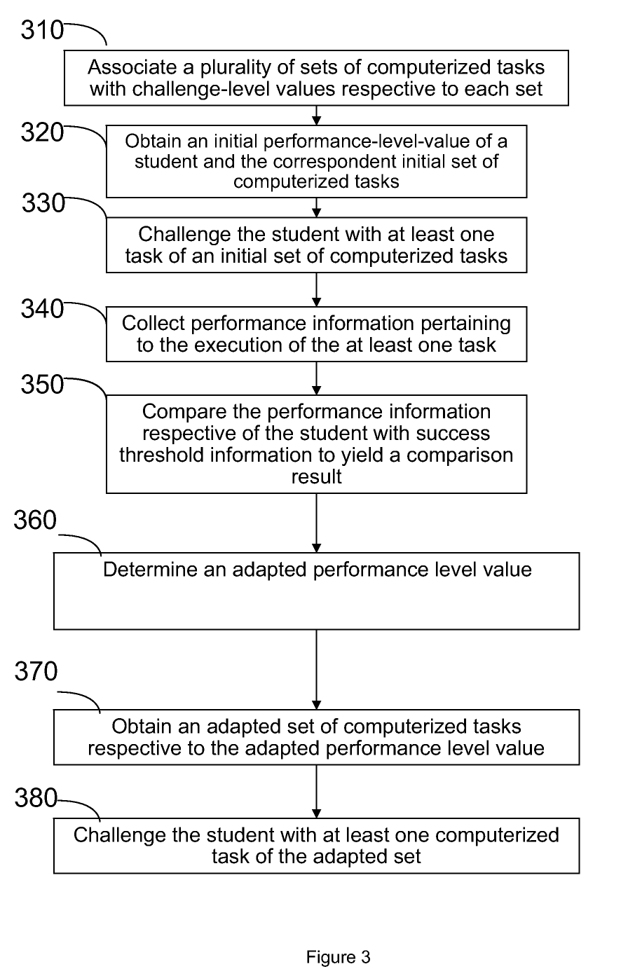

Referring now to FIG. 3, a schematic flow-chart of a method for challenging a student using the automatically adapted performance-level-values respective of the student, according to some embodiments of the invention, is illustrated. The adaptive learning method, or a method for challenging the student may for example include, as indicated by box 310, the act of associating a plurality of sets of computerized tasks with challenge-level-values respective to each set.

According to some embodiments of the invention, the method includes, as indicated by box 320, the act of obtaining an initial performance-level value.

According to some embodiments of the invention, the method includes, as indicated by box 330, the act of challenging the student with at least one computerized task of an initial set of tasks, whereby the challenge-level-values of the at least one computerized task is in correlation with the initial performance-level-value.

According to some embodiments of the invention, the method includes, as indicated by box 340, the act of collecting performance information pertaining to the execution of the at least one computerized task by the student.

According to some embodiments of the invention, the method includes, as indicated by box 350, the act of comparing the performance information respective of the student with the success-threshold-information to yield a comparison result.

According to some embodiments of the invention, the method includes, as indicated by box 360, the act of determining an adapted performance-level-value. The adapted performance-level-value may be determined according to the comparison result. Further, the adapted performance-level-value may also be determined according to the initial performance-level-value.

According to some embodiments of the invention, the method includes as indicated by box 370, the act of obtaining an adapted set of computerized tasks respective to the adapted performance-level-value.

According to some embodiments of the invention, the method includes, as indicated by box 380, the act of challenging the student with at least one computerized task of the adapted set.

In accordance with certain embodiments, the present invention also includes a method of determining an adaptive challenge-level-value respective of a computerized task. Each computerized task has associated thereto an initial challenge-level-value, whereby a challenge-level-value may correspond to the degree of difficulty of a computerized task.

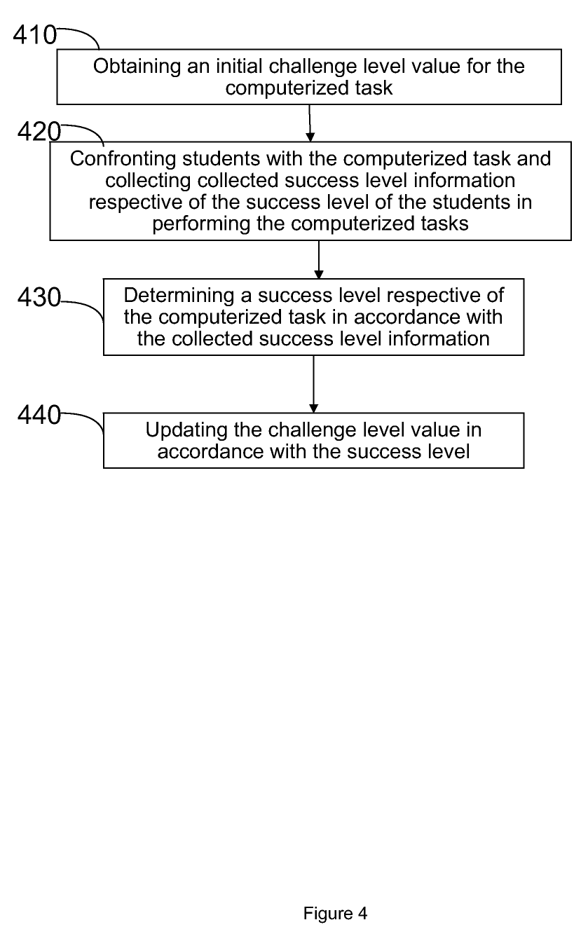

Additional reference is now made to FIG. 4, which shows a schematic flow-chart illustration of a method for challenging a student using automatically adaptable challenge-level-values respective of a computerized task, according to some embodiments of the invention. The adaptive e-learning system and method enable challenging students with the computerized task and collecting collected success level information determining a success level respective of the computerized task. The success level information collected relates to the success of the students in performing the said computerized task and rates the success level of each student with relation to computerized task. The success level information of all or some of the students with regard to the computerized task is then compared with the success-threshold-information, to yield comparison results. If for example, the comparison yields that the relation between the success level of all students tested and the success-threshold-information, for example information relating to an average of success of average students with regard to an average task, is above a predefined threshold value, (which may mean that the computerized task is too easy for an average student), then the system and/or method may determine an adapted challenge-level-value respective of the said computerized task. The success-threshold-information may also be an averaged value and/or a median value and/or any other statistical value derived from other success level values respective to a computerized task.

The adaptive e-learning method, or a method for challenging the student includes, as indicated by box 410, the act of obtaining an initial challenge-level-value for a computerized task.

According to some embodiments of the invention, the method includes, as indicated by box 420, the act of challenging students with the computerized task and collecting collected success level information respective of the success of the students in performing the computerized tasks.

According to some embodiments of the invention, the method includes, as indicated by box 430, the act of determining a success level respective of the computerized task in accordance with said collected success level information.

According to some embodiments of the invention, the method includes, as indicated by box 440, the act of updating the challenge-level-value in accordance with the success level.

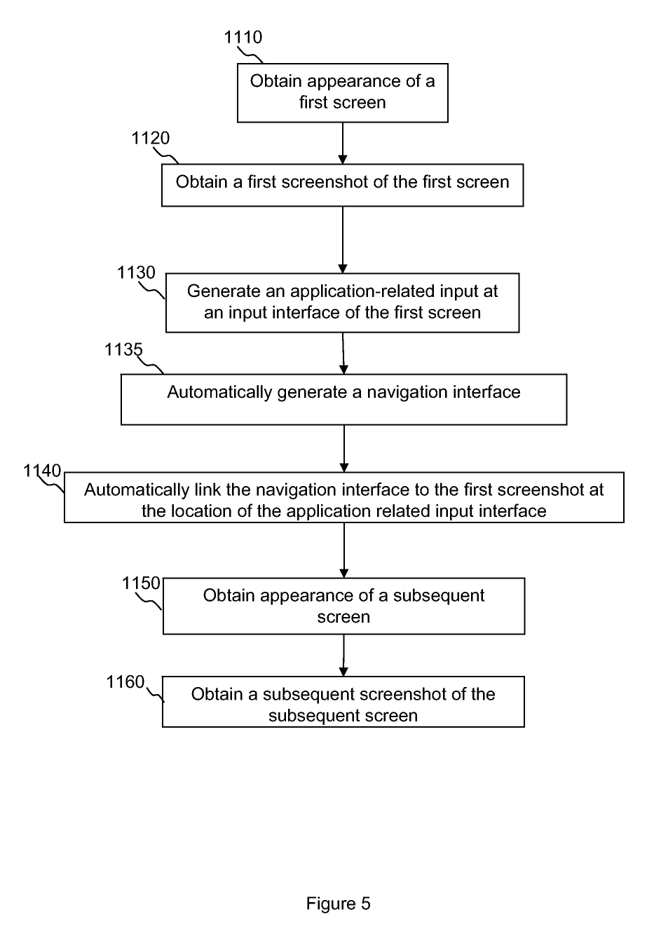

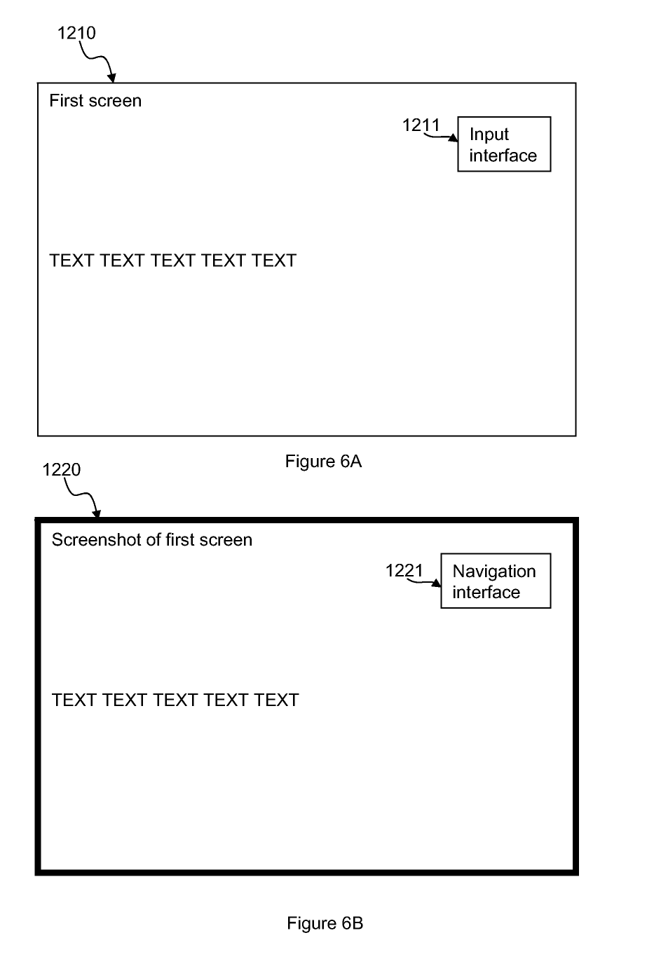

Reference is now made to FIG. 5, FIG. 6A and FIG. 6B. According to some embodiments of the invention, a method for allowing navigation between screenshots of a computerized application includes, as indicated by box 1110, the procedure of obtaining an appearance of a first screen 1210 of a computerized application.

According to some embodiments of the invention, the method includes, as indicated by box 1120, obtaining a first screenshot 1220 of first screen 1210 in response to the receipt of the application-related input.

According to some embodiments of the invention, the method may for example include, as indicated by box 1130, generating an application-related input at an input interface 1211 of, e.g., first screen 1210. The application-related input may be provided by a user by means of an input unit (not shown) such as, for example, a pointing device (e.g., a joystick, a computer-mouse, and the like), a keyboard and/or by any other suitable input unit, e.g., as known in the art.

Input interface 1211 may be embodied by a widget by a graphical interface. Non-limiting examples of a graphical symbol may represent, inter alia, an icon, a virtual push button, a virtual scroll bar, a virtual radio button, a virtual graphics input field such as, for example, a text box (e.g., for entering a string such as, for example, a password and/or a login name and/or an answer and/or a code and the like); a virtual combo box; a virtual toggle button; a virtual check box; a virtual slider; a virtual list box; a virtual spinner; a virtual rotating knob; a tab; a link; a hyperlink; a data field of a grid; a label; a header (e.g., of a list); a drop-down list; an item of a tree view interface; a combutcon interface; an accordion interface and the like, a drag & drop function. Such a widget may enable accessing, initiating, closing, terminating and/or modifying a function and/or a feature of a program and/or of an application. For example, providing a suitable application-related input to a widget by means of the input unit may enable the opening and closing of a file and/or a directory, and/or a window and/or an option of, e.g., an application.

Additionally or alternatively, input interface 1211 itself may be embodied by the input unit, e.g., as known in the art by, for example, one or more keys of a keypad and/or of a keyboard. For example, pressing a combination of keys (e.g., an “Alt” key+an “F4” key of a computer keyboard) may trigger the termination of an application and/or the closure of a virtual graphic window.

It should be noted that in some embodiments of the invention, obtaining first screenshot 1220 may be accomplished in response to an input other than the application-related input. Correspondingly, the order of the acts indicated by boxes 1110 and 1130 may be reversed in some embodiments of the invention such that the method may first include the act of generating the application input, and only then the act obtaining the first screenshot 1220.

According to some embodiments of the invention, the method may for example include, as indicated by box 1135, the procedure of automatically generating a computerized object (hereinafter referred to as “navigation interface”) 1221. Navigation interface 1221 may be a copy or substantially a copy of and/or may correspond to input interface 1211. Thus, navigation interface 1221 enables simulating and/or emulating the feature(s) and/or function(s) enabled by input interface 1211. Accordingly, the procedure of generating navigation interface 1221 may include the act of returning data representing the function(s) that is/are enabled by input interface 1211 (e.g., “close (window), “open” (window), “cancel”); procedure act of returning data representing at least some or all of the graphical features of input interface 1211 (e.g., shape and color); and the act of returning data representing the location of input interface 1211 (e.g., coordinates of each pixel of input interface 1211) at an output unit (not shown).

According to some embodiments of the invention, the method may for example include, as indicated by box 1140, the act of automatically linking navigation interface 1221 to first screenshot 1220. Correspondingly, navigation interface 1221 may be displayed on first screenshot 1220 at the same location or substantially at the same location as input interface 1211. Furthermore, the graphical representation of navigation interface 1221 on first screenshot 1220 of first screen 1210 is similar or equal to the graphical representation of input interface 1211 on first screen 1210.

It should be noted that in the event that input interface 1211 is embodied by the input unit, e.g., as known in the art, then the acts of returning data representing at least some or all of the graphical features of input interface 1211 (e.g., shape and color); and the act of returning data representing the location of input interface 1211 (e.g., coordinates of each pixel of input interface 1211) may be omitted. Instead, data representing the address(es) of the input unit (e.g., address of “Alt” key and address of “F4” key) may be returned and associated to navigation interface 1221 such that providing the application-related input by means of input interface 1211 embodied by the input unit allows navigation from first screenshot 1220 to subsequent screenshot 1320, as will be outlined hereinbelow.

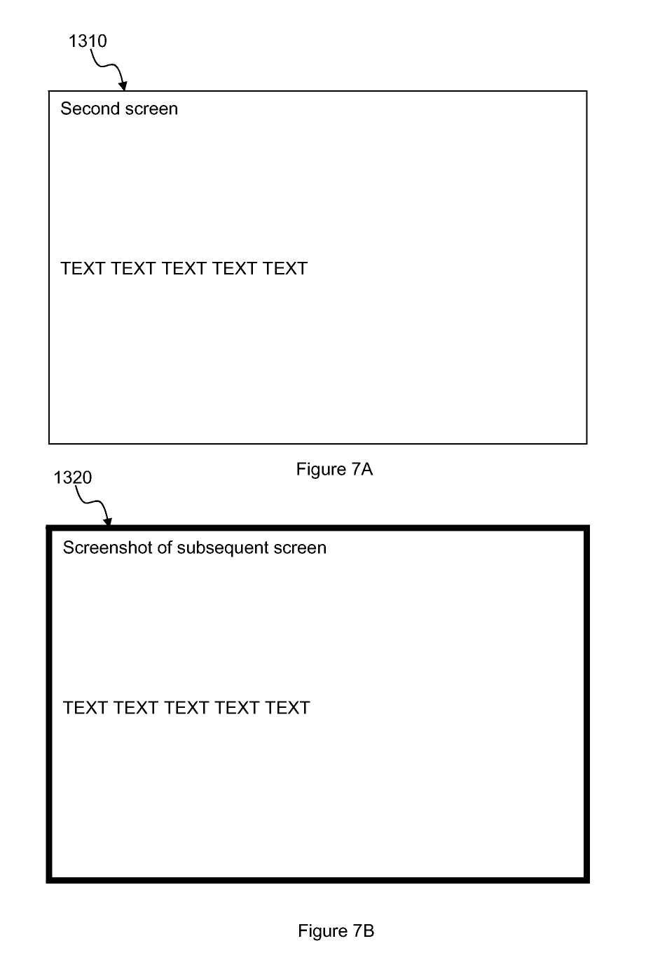

Additional reference is now made to FIG. 7A and FIG. 7B. According to some embodiments of the invention, the method may for example include, as indicated by box 1150, the procedure of obtaining an appearance of a subsequent screen 1310 in response to generating the application-related input at input interface 1211 of the first screen 1210.

According to some embodiments of the invention, the method may for example include, as indicated by box 1160 the procedure of obtaining a subsequent screenshot 1320 of subsequent screen 1310, whereby navigation from first screenshot 1220 to subsequent screenshot 1320 is conditioned to the receipt of a user-input at first screenshot 1220, wherein the user-input is similar to the application-related input. Correspondingly, obtaining a user-input that is similar to the application-related input allows navigation from first screenshot 1220 to subsequent screenshot 1320.

It should be understood that an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions.

It should be understood that the phraseology and terminology employed herein is not to be construed as limiting, and is for descriptive purpose only.

The principles and uses of the teachings of the present invention may be better understood with reference to the accompanying description, figures and examples.

It should be understood that the details set forth herein do not construe a limitation to an application of the invention. Furthermore, it should be understood that the invention can be carried out or practiced in various ways and that the invention can be implemented in embodiments other ways than the ones outlined in the description below.

It should be understood that the terms “including”, “comprising”, “consisting” and grammatical variants thereof do not preclude the addition of one or more components, features, steps, integers or groups thereof and that the terms are not to be construed as specifying components, features, steps or integers.

If the specification or claims refer to “an additional” element, that does not preclude there being more than one of the additional element.

It should be understood that where the claims or specification refer to “a” or “an” element, such reference is not to be construed as there being only one of that element.

It should be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

The term “method” refers to manners, means, techniques and procedures for accomplishing a given task including, but is not limited to those manners, means, techniques and procedures either known to, or readily developed from known manners, means, techniques and procedures by practitioners of the art to which the invention belongs.

Although some demonstrative embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The descriptions, examples, methods and materials presented in the claims and the specification are not to be construed as limiting but rather as illustrative only.

Meanings of technical and scientific terms used herein ought to be commonly understood as by one of ordinary skill in the art to which the invention belongs, unless otherwise defined.

The present invention can be implemented in the testing or practice with methods and materials equivalent or similar to those described herein.

While the invention has been described with respect to a limited number of embodiments, these should not be construed as limitations on the scope of the invention, but rather as exemplifications of some of the embodiments. Those skilled in the art will envision other possible variations, modifications, and programs that are also within the scope of the invention. Accordingly, the scope of the invention should not be limited by what has thus far been described, but by the appended claims. Therefore, it should be understood that alternatives, modifications, and variations of the present invention are to be construed as being within the scope of the appended claims.

It should be understood that some embodiments of the invention may be implemented, for example, using a machine-readable medium or article which may store an instruction or a set of instructions that, if executed by a machine, cause the machine to perform a method or operations or both in accordance with embodiments of the invention. Such a machine-readable medium may include, for example, any suitable processing platform, computing platform, computing device, processing device, computing system, processing system, computer, processor, or the like, and may be implemented by hardware and/or software, and/or firmware and/or hybrid modules. The machine-readable medium or article may include but is not limited to, any suitable type of memory unit, memory device, memory article, memory medium, storage article, storage unit, storage medium or storage unit such as, for example, memory, removable or non-removable media, erasable or non-erasable media, writeable or re-writeable media or non-rewriteable media, digital or analog media, random access memory (RAM), flash memory, read-only-memory (ROM), programmable ROM, Erasable Programmable ROM, Electrically Erasable Programmable ROM, optical disk, hard disk, floppy disk, Compact Disk Recordable (CD-R), Compact Disk Read Only Memory (CD-ROM), Compact Disk Rewriteable (CD-RW), magnetic media, various types of Digital Versatile Disks (DVDs), a rewritable DVD, a tape, a cassette, or the like. The instructions may include any suitable type of code, for example, an executable code, a compiled code, a dynamic code, a static code, interpreted code, a source code or the like, and may be implemented using any suitable high-level, low-level, object-oriented, visual, compiled and/or interpreted programming language and/or programming environment. Such a compiled and/or interpreted programming language and/or environment may be, for example, C, C++, C#, .Net, Java, Pascal, MATLAB, BASIC, Cobol, Fortran, assembly language, machine code and the like.

What is claimed is:

1. A method of challenging a student using automatically adapted performance-level values respective of the student, the method comprising:
obtaining an initial performance-level-value;
obtaining an initial set of computerized tasks, each task in the initial set has a respective challenge-level-value correlated with the initial performance-level-value;
challenging the student with one or more of the computerized tasks being members in the initial set and collecting performance information respective of performance of the student;
comparing the performance information with success-threshold-information to yield comparison results;
determining an adapted performance-level-value respective of the student in accordance with the initial performance-level-value and the comparison results;
obtaining an adapted set of computerized tasks, each task in the adapted set has a respective challenge-level-value corresponding with the adapted performance-level-value; and
challenging the student with one or more of the computerized tasks being members in the adapted set.

2. The method of claim 1, wherein said initial performance-level-value is at least one of the following group: a specific performance level value respective of a specific student; a general performance level value respective of a group of students; a general performance level value respective of all students; and a predefined default value;

3. The method of claim 1, wherein one or more of the computerized tasks being members in the initial set is similar to one or more of the computerized tasks being members in the adapted set.

4. A method of determining an adaptable challenge-level-value respective of a computerized task, the method comprising:
obtaining an initial challenge-level value-for the computerized task;
challenging students with the computerized task and collecting collected success level information respective of success of the students in performing the computerized tasks;
determining a success level respective of the computerized task in accordance with said collected success level information; and
updating the challenge-level-value in accordance with the success level.

5. A method for allowing navigation between screenshots of a computerized application, the method comprising:
obtaining an appearance of a first screen and an appearance of a subsequent screen of a computerized application, said subsequent screen is obtainable further to receiving a corresponding application-related input;
obtaining a first screenshot of the appearance of said first screen and a subsequent screenshot of the appearance of said subsequent screen; and
automatically linking a navigation interface to said first screenshot, for allowing navigation to said subsequent screenshot by obtaining an input which is similar to said application-related input.

6. A system adapted for allowing navigation between screenshots of a computerized application, said system comprising:
a computer module enabling obtaining an appearance of a first screen and an appearance of a subsequent screen of a computerized application, said subsequent screen is obtainable further to receiving a corresponding application-related input;
said computer module further enabling obtaining a first screenshot of the appearance of said first screen and a subsequent screenshot of the appearance of said subsequent screen; and
said computer module enabling to automatically link a navigation interface to said first screenshot, for allowing navigation to said subsequent screenshot by obtaining an input which is similar to said application-related input.
